(19) United States
(12) Patent Application Publication
(10) Pub. No.: US 2016/0252430 A1
(43) Pub. Date: Sep. 1, 2016

(54) SYSTEMS AND METHODS FOR DETERMINING VEHICLE LONGEVITY

(71) Applicant: GM GLOBAL TECHNOLOGY OPERATIONS LLC, DETROIT, MI (US)

(72) Inventors: ROD M. TESIC, FARMINGTON HILLS, MI (US); DANIEL J. REAUME, LIVONIA, MI (US)

(73) Assignee: GM GLOBAL TECHNOLOGY OPERATIONS LLC

(21) Appl. No.: 14/634,759

(22) Filed: Feb. 28, 2015

(51) Int. Cl. G01M 17/00

(52) U.S. Cl. CPC G01M 17/00

(57) ABSTRACT

The present technology relates to systems and methods for calculating vehicle longevity. The methods use steps that are repeatable and thus the results of the methods are objective can include projections regarding how long a longevity claim can be supported into the future.

### TECHNICAL FIELD

The present disclosure relates generally to vehicle longevity.

### BACKGROUND

Advertising claims require logic to back up the claim. Calculations of vehicle longevity are useful, for example, to support advertising claims. However, although claims are backed by hard numbers, certain previously used methods of calculating vehicle longevity claims include subjective steps. Due to the subjective steps, previously used methods of calculating vehicle longevity are not easily repeatable, the results of the methods are less objective, and it is difficult to project the accuracy of support for longevity claims into the future.

In addition, previously used methods use a model for calculating longevity that applies different weights to different model years. However, the weights are difficult to determine. For example, for recently sold vehicles, it is difficult to determine a weight that reflects longevity and is not influenced by exogenous factors such as fire or flood.

### SUMMARY

The present technology relates to systems and methods for calculating vehicle longevity. The methods use steps that are repeatable and thus the results of the methods are objective and can include projections of how long a longevity claim can be supported into the future.

The present technology identifies critical stages in the vehicle aging process; uses objective and scalable process for validating longevity-based advertising claims; and provides uncertainty estimates as well as shelf life for proposed claims.

Other aspects of the present invention will be in part apparent and in part pointed out hereinafter.

### DESCRIPTION OF THE DRAWINGS

FIG. 1 illustrates schematically a system including a computing architecture, according to an embodiment of the present disclosure.

FIG. 2 illustrates a method, according to an embodiment of the present disclosure.

FIG. 3 illustrates is a chart illustrating an aggregated vehicle in operation (VIO) residual time series.

FIG. 4 is a chart illustrating a first make VIO residual time series.

FIG. 5 is a bar graph illustrating values of vehicle longevity.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

While the present technology is described primarily herein in connection with longevity of trucks, the technology is not limited to such vehicles or products. The concepts can be used in a wide variety of applications, such as in connection with aircraft, marine craft, farm equipment, construction equipment, major home appliances, and other.

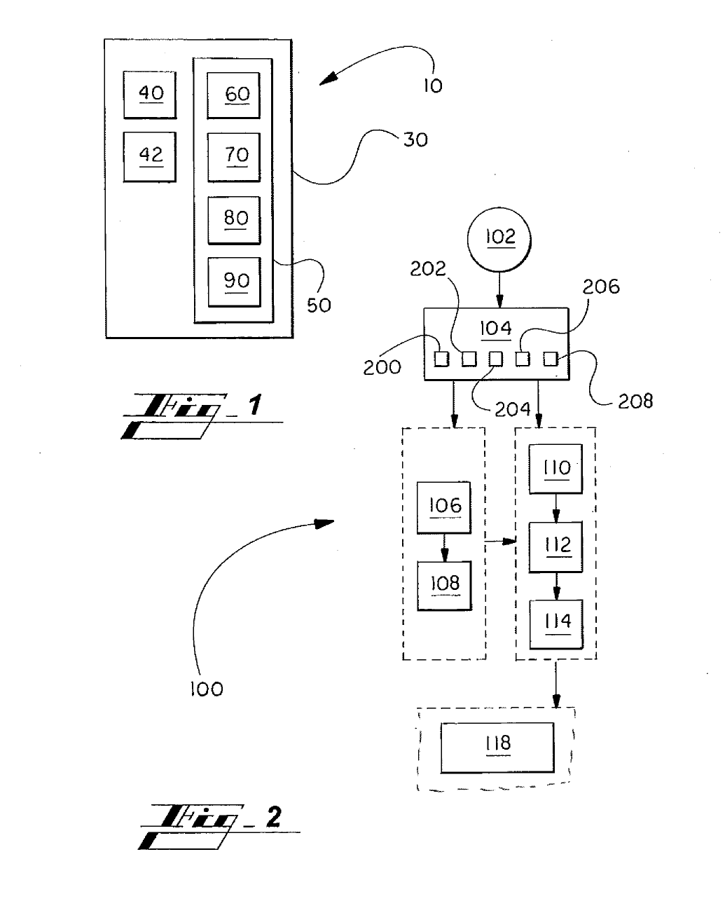

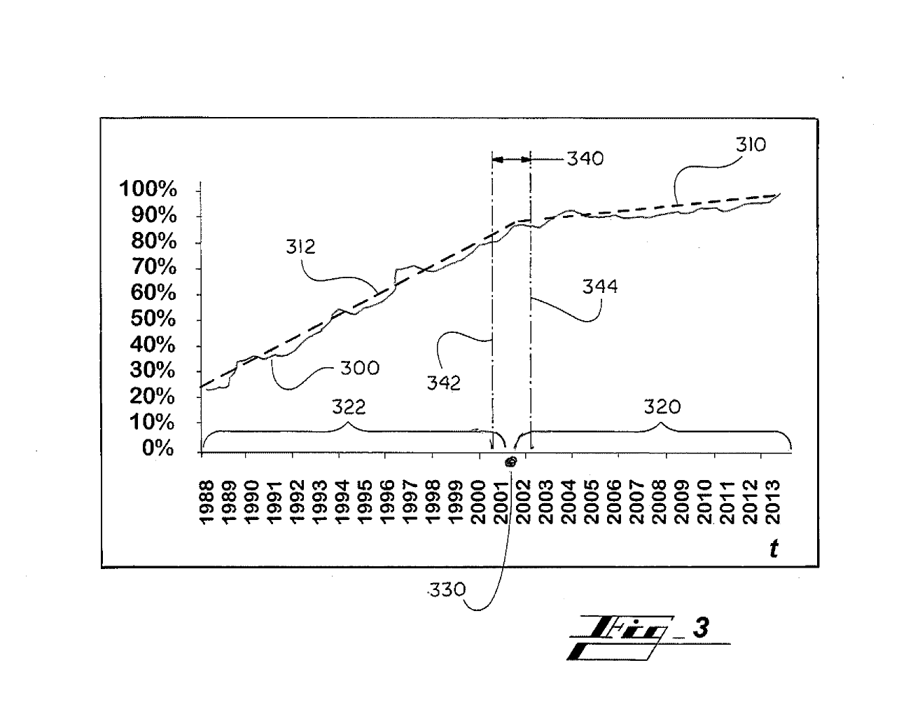

According to one embodiment, FIG. 1 shows a system 10 configured to perform methods such as the method 100 shown in FIG. 2. FIG. 1 illustrates schematically features of the system 10. The system 10 includes a computing unit 30. The computing unit 30 includes a processor 40 for controlling and/or processing data, input/output data ports 42, and a memory 50. Connecting infrastructure within the system 10, such as one or more data buses and wireless transceivers, is not shown in detail in order to simplify the figures.

The processor could be multiple processors, which could include distributed processors or parallel processors in a single machine or multiple machines. The processor could include virtual processor(s). The processor could include a state machine, application specific integrated circuit (ASIC), programmable gate array (PGA) including a Field PGA, or state machine. When a processor executes instructions to perform “operations,” this could include the processor performing the operations directly and/or facilitating, directing, or cooperating with another device or component to perform the operations.

The memory 50 can include a variety of computer-readable media, including volatile media, non-volatile media, removable media, and non-removable media. The term “computer-readable media” and variants thereof, as used in the specification and claims, includes storage media. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that is configured to be used to store information that can be accessed by the processor 40.

While the memory 50 is illustrated as residing proximate the processor 40, it should be understood that at least a portion of the memory can be a remotely accessed storage system, for example, a server on a communication network, a remote hard disk drive, a removable storage medium, combinations thereof, and the like. Thus, any of the data, applications, and/or software described below can be stored within the memory and/or accessed via network connections to other data processing systems (not shown) that may include a local area network (LAN), a metropolitan area network (MAN), or a wide area network (WAN), for example.

The memory 50 includes several categories of software and data used in the computing unit 30 including applications 60, a database 70, an operating system 80, and input/output device drivers 90.

The operating system 80 may be any operating system for use with a data processing system. The input/output device drivers 90 may include various routines accessed through the operating system 80 by the applications to communicate with devices, and certain memory components. The applications 60 can be stored in the memory 50 and/or in a firmware (not shown) as executable instructions, and can be executed by the processor 40.

The applications 60 include various programs that, when executed by the processor 40, implement the various features of the computing unit 30. The applications 60 include applications described in further detail with respect to exemplary methods. The applications 60 are stored in the memory 50 and are configured to be executed by the processor 40.

The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The applications 60 may use data stored in the database 70. The database 70 includes static and/or dynamic data used by the applications 60, the operating system 80, the input/output device drivers 90 and other software programs that may reside in the memory 50.

It should be understood that FIG. 1 and the description above are intended to provide a brief, general description of a suitable environment in which the various aspects of some embodiments of the present disclosure can be implemented. While the description refers to computer-readable instructions, embodiments of the present disclosure also can be implemented in combination with other program modules and/or as a combination of hardware and software in addition to, or instead of, computer readable instructions.

FIG. 2 shows an exemplary method 100 that facilitates analyzing vehicle longevity, according to an embodiment of the present disclosure. It should be understood that the steps of the method 100 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

It should also be understood that the illustrated method 100 can be ended at any time. In certain embodiments, some or all steps of this process, and/or substantially equivalent steps are performed by execution of computer-readable instructions stored or included on a computer readable medium, such as the memory 50 of the computing unit 30 described above, for example.

Referring to FIG. 2, the method 100 begins 102 and flow proceeds to blocks 104, 106, 108, 110, 112, 114, 116, 118. Blocks 106, 108 are associated with computer executable instructions for identifying a threshold separation point based on an aggregated VIO residual time series. The separation point represents a point in time where vehicles are failing due to aging. Blocks 110, 112, 114, 116 are associated with computer executable instructions for calculating a current longevity value based on a make VIO residual time series and the threshold separation point. Block 118 is associated with computer executable instructions for calculating a future longevity value for based on a make VIO residual time series and an adjusted time window.

In block 104, the processor 40 accesses an aggregated data set 200 and make data sets 202, 204, 206, 208 that are stored in the memory 50.

As used herein, the aggregated data set 200 is associated with a segment of vehicles. For purposes of teaching, a segment of vehicles is a category of vehicles. For example, a segment of vehicles is full-size pickup trucks, mid-size pickup trucks, or any other category of vehicles.

The aggregated data set 200 is an aggregation of data based on the make data sets 202, 204, 206, 208. The make data sets 202, 204, 206, 208 are associated with different makes (e.g., the various makes 502, 504, 506, 508 shown in FIG. 5) of the vehicles in the segment of vehicles. For example, a make in a segment is full-size pickup trucks for a single manufacturer.

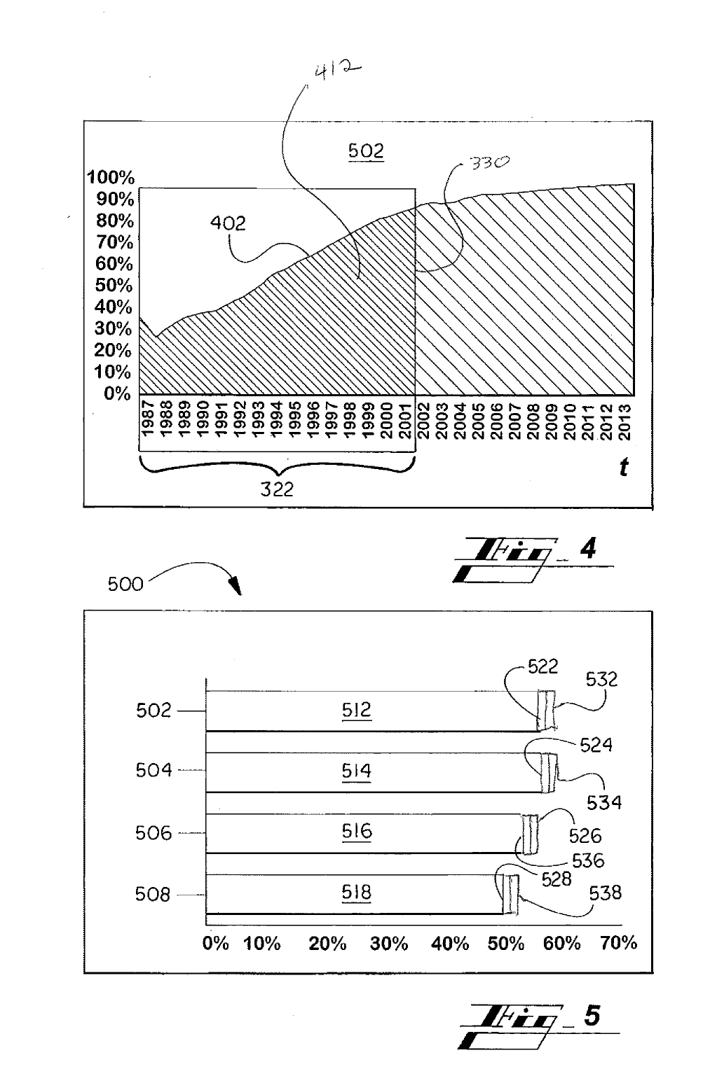

Referring momentarily to FIG. 4, the make data sets 202, 204, 206, 208 each include a vehicle in operation (VIO) residual time series for a respective make 502, 504, 506, 508, referred to as a make VIO residual time series (first make VIO residual time series 402 associated with first make 502 shown in FIG. 4). For example, each VIO residual (e.g., data point) in the first make VIO residual time series 402 is a VIO residual of the respective make for a model year (MY). A VIO residual, calculated as a percentage (%), for a model year and make, is the number of vehicles that remain in operation divided by the total historical number of vehicles in operation.

Similarly, referring momentarily to FIG. 3, the aggregated data set 200 includes a vehicle in operation (VIO) residual time series for all of makes 502, 504, 506, 508 in a segment, referred to as an aggregated VIO residual time series 300. For example, each VIO residual (e.g., data point) in the aggregated VIO residual time series 300 is a VIO residual for a model year (MY), calculated as a percentage (%), and is the number of vehicles that remain in operation for all of makes 502, 504, 506, 508 in the segment divided by the total historical number of vehicles in operation for all makes 502, 504, 506, 508 in the segment.

The data is screened for data anomalies and outliers. For example, a VIO residual that is higher than 100% is a data anomaly.

In alternative embodiments, the aggregated product data set is associated with a product group and is an aggregation of individual product data sets (e.g., a lower level of granularity with respect to the aggregated product data).

Referring to FIGS. 2 and 3, at the block 106, the aggregated VIO residual time series 300 is generated at a particular point in time (e.g., end of June, 2014). The y-axis is VIO residual (%) and the x-axis is time (t) with model years indicated. As described above, each VIO residual (e.g., data point) in the aggregated VIO residual time series 300 is calculated based on a sum of the number of vehicles in that remain in operation for all of makes 502, 504, 506, 508 in the segment divided by a sum of the total historical number of vehicles in operation for all makes 502, 504, 506, 508 in the segment.

In FIG. 3, a VIO residual of close to 100% is the VIO residual of model year 2013 (e.g., close to 100% of model year 2013 vehicles in this segment are on the road at the end of June 2014). That VIO residual gradually decreases moving in a direction toward later model years. The 1998 model year has a VIO residual of about 25%.

The aggregated VIO residual time series 300 does not decrease at a constant rate as the model year decreases. Rather, in general, the aggregated VIO residual time series 300 decreases at a slower rate over the more recent model years (e.g., those model years closer to 2013) and decreases at a faster rate over the older model years (e.g., those model years closer to 1998).

To illustrate this, a first constant slope line 310 is shown overlaying the aggregated VIO residual time series 300 of the more recent years and a second constant slope line 312 is shown overlaying the aggregated VIO residual time series 300 of the older model years. The first constant slope line 310 fits the aggregated VIO residual time series 300 for a first stage time period 320 and the second constant slope line 312 fits the aggregated VIO residual time series 300 for a second stage time period 322.

The aggregated VIO residual time series 300 in the first stage time period 320 represents attrition during the earlier years of the life of the vehicle and the aggregated VIO residual time series 300 in the second stage time period 322 represents attrition during the later years of the life of the vehicle. The slope of the second constant slope line 312 is approximately five times the slope of the first constant slope line 310. The change in slope represents different stages of attrition related to vehicle aging. Accordingly, the age-related vehicle attrition is more likely in the second stage time period 322 than in the first stage time period 320.

For example, the first stage time period 320 may be approximately the first ten years of the life of the vehicle. Here, all makes may perform similarly in terms of longevity. Attrition in the first stage time period 320 may be driven by exogenous factors such as flooding, fires, or accidents rather than the age of the vehicle. In other words, vehicle age is not the primary driver of vehicle attrition. As used herein, exogenous factors are those which are unrelated to vehicle durability.

The first-stage time period 320 and the second-stage time period 322 may be assumed to abut one another, separated by a separation point 330. Because there is generally not an exact point where the slope changes (e.g., the change is gradual), a range of separation points are possible (e.g., optimal values for separation points).

The separation point 330 may be any point within a range of separation points 340, as described in further detail below. The range of separation points 340 is bounded by a lower separation boundary 342 and an upper separation boundary 344.

At the block 108, the range of separation points 340 is determined by identifying the lower separation boundary 342 and the upper separation boundary 344. A method, such as piecewise linear regression, is used to identify the lower separation boundary 342 and the upper separation boundary 344. The following equations are used with piecewise linear regression:

y=b₀+b₁*x for x≦c

y=(b₀+b₁*c)+b₂*(x−c) for x>c

where y is the VIO residual, x is the time or model year, c is the separation point, b₀ is the intercept at the y-axis, b₁ is the slope of the line 312, and b₂ is the slope of the line 310.

First, test values for separation point (element 330 in FIG. 3 and variable c in equations) are selected. The test values for separation point 330 (c) can be determined, for example, by selecting a range of values around the bend in the aggregated VIO residual time series 300.

A test value in the range of test values for separation point 330 (c) is used as an input to the equations, thereby defining each of the first stage time period 320 (e.g., c to 2103) and the second stage time period 322 (e.g., 1998 to c).

A linear regression analysis is performed to fit a line (e.g., line 312) to the aggregated VIO residual time series 300 in the second stage time period 322, generating constants b₀, b₁. A linear regression analysis is performed to fit a line (e.g., line 310) to the aggregated VIO residual time series 300 in the first stage time period 320, using constants b₀, b₁ and generating constant b₂.

Each test value for separation point 330 (c) is in the range of separation points 340 if the variables b₀, b₁, b₂ that result from each linear regression analysis fit a line (e.g., lines 310, 312) to the aggregated VIO residual time series 300 in a respective stage time period, for example, with a statistical confidence level greater or equal to 95% (or another suitable confidence level). Particularly, a test value for separation point 330 (c) is one of the lower separation boundary 342 and the upper separation boundary 344 if the variables b₀, b₁, b₂ that result from each linear regression analysis fit a line (e.g., lines 310, 312) to the aggregated VIO residual time series 300 in a respective stage time period with a statistical confidence level approximately equal to 95%.

Each of the values in the range of separation points 340 objectively represents a structural break, which is also referred to as breakpoint, bend, kink, or flexion point. In other words, the range of separation points 340 includes values for separation point 330 (c) for which there is a 95% confidence level that the value is acceptable for use as the separation point 330 (c).

Using the values for the range of separation points 340 and a make VIO residual time series (e.g., the first make VIO residual time series 402), longevity is quantified for the make (e.g., first make 502).

At the block 110 of the method 100 of FIG. 2, the second stage time period 322 is defined by a value in the range of separation points 340. Referring to FIG. 4, a value for the separation point 330 (c) defines an end of the second stage time period 322. For example, using the different values of the separation boundaries 342, 344 as the value of the separation point 330 changes the width of the second stage time period 322.

At the block 112, the first make VIO residual time series 402 is numerically integrated over the second stage time period 322 to calculate a value for the first make longevity 512. In other words, a first area 412 under the first make VIO residual time series 402 is calculated. The first area 412 represents the average VIO residual in the second stage time period 322. The average VIO residual in the second stage time period 322 represents the first make longevity 512 of the first make 502. The first area 412 represents vehicle longevity because more area indicates more vehicles survived.

By integrating only over the second stage time period 322, the weight placed on longevity in the first stage time period 320 is essentially zero. In other words, the years between the current date (e.g., 2013) and the separation point 330 are given weight of zero.

Referring momentarily to FIG. 5, a range of values for a first make longevity 512 are calculated. Because the range of separation points 340 includes values for separation point 330 (c) for which there is a 95% confidence level that the value is acceptable for use as the separation point 330 (c), the calculated range of values for the first make longevity 512 are similarly acceptable to a 95% confidence level. The value of the lower separation boundary 342 is used to calculate a lower first make longevity boundary 522 and the upper separation boundary 344 is used to calculate an upper first make longevity boundary 532.

Using the value for the lower separation boundary 342 to define the second stage time period 322, the first make VIO residual time series 402 is integrated over the second stage time period 322 to calculate a value for the lower first make longevity boundary 522. Using the value for the upper separation boundary 344 to define the second stage time period 322, the first make VIO residual time series 402 is integrated over the second stage time period 322 to calculate a value for the upper first make longevity boundary 532.

The blocks 110, 112 are repeated for each make 504, 506, 508 resulting in values for second make longevity 514, third make longevity 516, fourth make longevity 518. For example, a value in the range of separation points 340 is used to define the second stage time period 322 and a respective one of a second make VIO residual time series, a third make VIO residual time series, and a fourth make VIO residual time series is integrated over the second stage time period 322.

Similarly, using values of the lower separation boundary 342 and the upper separation boundary 344 to define the second stage time period 322, a respective one of the second make VIO residual time series, the third make VIO residual time series, and the fourth make VIO residual time series is integrated over the second stage time period 322 to calculate the lower second make longevity boundary 524, the lower third make longevity boundary 526, the lower fourth make longevity boundary 528, the upper second make longevity boundary 534, the upper third make longevity boundary 536, and the upper fourth make longevity boundary 528.

Referring to FIG. 5, at the block 114, an object 500 is generated. Here, the object 500 is a bar graph visually displaying the values for make longevity 512, 514, 516, 518, each with its respective lower make longevity boundary 522, 524, 526, 528 and upper make longevity boundary 532, 534, 536, 538, for each of the makes 502, 504, 506, 508. The boundaries of the values for longevity can be compared to determine a statistically significant (to a 95% confidence level) difference in values for make longevity 512, 514, 516, 518. For example, the lower second make longevity boundary 524 is above the upper third make longevity boundary 536 so it is clear that the value of second make longevity 514 is greater than the value of third make longevity 516.

At the block 118, a value of longevity for a future year is calculated based on current make VIO residual timelines. Using the current make VIO residual time series, the second stage time period 322 is adjusted to approximate a future year, and the current make VIO residual time series is numerically integrated over the adjusted second stage time period 322 to calculate the future value of longevity.

By calculating future values of longevity for different makes, the makes can be compared as above into the future to estimate how long a current longevity claim will be valid.

One approach of adjusting the second stage time period 322 for each future year is to slide the second stage time period 322 forward in time one year while keeping the same width (by dropping the oldest years and adding a newest year). This approach mimics what happens as vehicles age as the oldest model year in the first stage time period 320 becomes the newest model year in the second stage time period 322. This approach assumes that any differences in the first stage time period 320 persist into the second stage time period 322. For example, a make is a certain percentage better in a model year that is currently in the first stage time period 320, it is assumed that the make stays that much better when that model year becomes part of the second stage time period 322.

A second approach is to expand the second stage time period 322 by, for each future year, adding a newest year to the second stage time period 322. The newest year is one year more than the current separation point 330.

A third approach is to shrink the second stage time period 322 by, for each future year, dropping the oldest year in the second stage time period 322. This approach assumes that there is industry parity after the separation point 330 and the only years that make a difference in longevity are the years that remain in the second stage time period 322.

Various embodiments of the present disclosure are disclosed herein. The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method, comprising:
determining, by a system comprising a processor, using an aggregated vehicle in operation (VIO) residual timeseries, a range of separation point values, wherein the range of separation point values is defined by a lower separation boundary value and an upper separation boundary value, wherein a separation point separates a first stage time period from a second stage time period;
calculating, by the system, a first make vehicle longevity value by numerically integrating a first make VIO residual timeseries over the second stage time period, wherein an end of the second stage time period is defined by a selected value in the range of separation point values; and
generating, by the system, an object visually displaying the first make vehicle longevity value.

2. The method of claim 1, further comprising determining, by the system, the selected value in the range of separation values using a piecewise linear regression model.

3. The method of claim 1, further comprising:
calculating, by the system, a second make vehicle longevity value by numerically integrating a second make VIO residual timeseries over the second stage time period, wherein an end of the second stage time period is defined by the selected value in the range of separation point values; and
generating, by the system, the object visually displaying the second make vehicle longevity value.

4. The method of claim 1, further comprising:
calculating, by the system, a first make vehicle longevity range of values, the first make vehicle longevity range of values being defined by a lower first make longevity boundary value and an upper first make longevity boundary value,
wherein the lower first make longevity value is calculated by numerically integrating the first make VIO residual timeseries over the second stage time period, wherein an end of the second stage time period is defined by the lower separation boundary value; and
wherein the upper first make longevity value is calculated by numerically integrating the first make VIO residual timeseries over the second stage time period, wherein an end of the second stage time period is defined by the upper separation boundary value; and
generating, by the system, an object visually displaying the first make vehicle longevity range of values.

5. The method of claim 4, further comprising:
calculating, by the system, a second make vehicle longevity range of values, the second make vehicle longevity range of values being defined by a lower second make longevity boundary value and an upper second make longevity boundary value,
wherein the lower second make longevity value is calculated by numerically integrating a second make VIO residual timeseries over the second stage time period, wherein an end of the second stage time period is defined by the lower separation boundary value; and
wherein the upper second make longevity value is calculated by numerically integrating the second make VIO residual timeseries over the second stage time period, wherein an end of the second stage time period is defined by a the upper separation boundary value; and
generating, by the system, the object further visually displaying the second make vehicle longevity range of values.

6. The method of claim 1, wherein a first slope of the aggregated VIO residual timeseries in the first stage time period is less than a second slope of the aggregated VIO residual timeseries in the second stage time period.

7. The method of claim 1, further comprising determining, by the system, the lower separation boundary value and the upper separation boundary value using a piecewise linear regression model.

8. The method of claim 7, wherein each of the lower separation boundary value and the upper separation boundary value is based on a statistical confidence level.

9. The method of claim 8, wherein the statistical confidence level reflects how well the piecewise linear regression model fits the aggregated VIO residual timeseries.

10. The method of claim 7, wherein the piecewise linear regression model is given as y=b₀+b₁*x for x≦c and y=(b₀+b₁*c)+b₂*(x−c) for x>c, where y is a VIO residual, x is a time, c is the separation point, b₀ is an intercept at a y-axis, b₁ is a slope of a second line in the second stage time period, and b₂ is a slope of a first line in the first stage time period.

11. The method of claim 1, wherein the second stage time period represents attrition during a life of the vehicle later than the time defined by the separation point.

12. The method of claim 1, wherein the aggregated VIO residual timeseries includes a VIO residual that is calculated based on a number of vehicles that remain in operation for all makes in a segment of vehicles divided by a total historical number of vehicles in operation for all makes in a the segment of vehicles.

13. The method of claim 1, wherein the first make VIO residual timeseries includes a VIO residual that is calculated based on a number of vehicles that remain in operation for a first make divided by a total historical number of vehicles in operation for the first make.

14. The method of claim 1, further comprising calculating, by the system, a predictive first make vehicle longevity value by numerically integrating a first make VIO residual timeseries over an adjusted second stage time period, wherein at least one end of the second stage time period is adjusted to define the adjusted second stage time period.

15. The method of claim 14, wherein each end of the adjusted second stage time period is shifted forward in time by an amount reflecting time of prediction into the future and the adjusted second stage time period has a time window being a time window of an original second stage time period.

16. The method of claim 14, wherein one end of the adjusted second stage time period is shifted forward in time by an amount reflecting time of prediction into the future and the adjusted second stage time period has a time window that is greater than a time window of an original second stage time period.

17. The method of claim 14, wherein one end of the adjusted second stage time period is shifted forward in time by an amount reflecting time of prediction into the future and the adjusted second stage time period has a time window that is less than a time window of an original second stage time period.

18. A system, comprising:
a processor;
a memory comprising instructions that, when executed by the processor, cause the processor to perform operations comprising:
determining, using an aggregated vehicle in operation (VIO) residual timeseries, a range of separation point values, wherein the range of separation point values is defined by a lower separation boundary value and an upper separation boundary value, wherein a separation point separates a first stage time period from a second stage time period;
calculating, a first make vehicle longevity value by numerically integrating a first make VIO residual timeseries over the second stage time period, wherein an end of the second stage time period is defined by a selected value in the range of separation point values; and
generating, an object visually displaying the first make vehicle longevity value.

19. The system of claim 18, further comprising determining the selected value in the range of separation values using a piecewise linear regression model.

20. A computer-readable medium comprising instructions that, when executed by a processor, cause the processor to perform operations comprising:
determining, using an aggregated vehicle in operation (VIO) residual timeseries, a range of separation point values, wherein the range of separation point values is defined by a lower separation boundary value and an upper separation boundary value, wherein a separation point separates a first stage time period from a second stage time period;
calculating, a first make vehicle longevity value by numerically integrating a first make VIO residual timeseries over the second stage time period, wherein an end of the second stage time period is defined by a selected value in the range of separation point values; and
generating, an object visually displaying the first make vehicle longevity value.
